(19) United States
(12) Patent Application Publication
(10) Pub. No.: US 2008/0277561 A1
(43) Pub. Date: Nov. 13, 2008

(54) MOLD BOX AND METHOD OF MANUFACTURING MULTIPLE BLOCKS

(75) Inventor: Robert A. MacDonald, Plymouth, MN (US)

Correspondence Address: POPOVICH, WILES & O'CONNELL, PA;650 THIRD AVENUE SOUTH, SUITE 600, MINNEAPOLIS, MN, 55402, US

(73) Assignee: KEYSTONE RETAINING WALL SYSTEMS, INC., Bloomington, MN (US)

(21) Appl. No.: 12/118,103

(22) Filed: May 9, 2008

Related U.S. Application Data
(60) Provisional application No. 60/928,831, filed on May 11, 2007.

(51) Int. Cl. B28B 7/02; E04B 1/00

(52) U.S. Cl. 249/158; 52/742.14

(57) ABSTRACT

A mold box with an angled division plate and methods for making blocks of various shapes and sizes and columns and walls constructed with the blocks. Multiple embodiments of the mold box are disclosed for enabling different numbers of blocks and sizes of blocks to be formed in a single mold box.

This application claims the benefit of U.S. Provisional Application No. 60/928,831, filed May 11, 2007, entitled “Mold Box and Method of Manufacturing Multiple Blocks”, the contents of which are hereby incorporated by reference herein.

### FIELD OF THE INVENTION

This invention relates generally to a mold box and a method of manufacturing wall blocks using the mold box. More particular the invention relates to a mold box and a method of manufacturing blocks of multiple sizes and shapes and the construction of columns and walls from the manufactured blocks.

### BACKGROUND OF THE INVENTION

In the manufacture of retaining wall blocks and other kinds of blocks made from concrete, it is common to use a mold that forms a block module which is then split to form two or more blocks. When a block module is split, the split surface has an irregular appearance, which is desirable if the desired look is one of natural stone. A split block appearance has a desirable appearance for many applications, such as retaining walls and landscaping products.

A typical retaining wall block has substantially parallel top and bottom surfaces and substantially parallel front and back surfaces. Side surfaces may have various angles or contours relative to the front and back surfaces, or could also be substantially parallel. In forming block modules of such blocks, it is often standard practice to split a block module on a plane coincident with the front faces of two blocks, thus giving the front faces of two opposing blocks an irregular (i.e., roughened) appearance.

U.S. Pat. No. 5,827,015 describes the conventional dry cast manufacturing process used to manufacture concrete wall blocks. In such process, a mold box is used to form a slab that is subsequently split into two wall blocks. It is also known to provide mold boxes which can simultaneously form multiple slabs of identical size and shape. Presently, however, users desire to create walls that have a non-uniform shape by using blocks having more than one size or shape. The process of manufacturing multiple block sizes and shapes presents an increased cost due to the need to use multiple different mold boxes corresponding to each size and shape of block to be manufactured, or to forfeit space and efficiency in the mold box when creating blocks of different lengths and end angles.

It would be desirable to manufacture multiple block sizes from a single mold box.

It would be further desirable to manufacture multiple shaped wall blocks from a single mold box.

It would be further desirable to produce a column from the multiple wall blocks produced from the single mold box that had a natural, weathered appearance and that could be used to construct 90° corners.

It would be further desirable to produce a wall from the multiple wall blocks produced from the single mold box.

It would be further desirable to produce curved walls, retaining walls, free-standing walls, partial retaining walls, pilasters and walls with 90° corners with the multiple wall blocks of the present invention.

### SUMMARY OF THE INVENTION

The present invention relates to a mold box and to methods for making blocks of various shapes and sizes using the mold box. The mold box is provided with an angled division plate. The invention also relates to the blocks formed in the mold box and methods of constructing columns and walls with the blocks. Multiple embodiments of the mold box are disclosed for enabling different numbers of blocks and sizes of blocks to be formed in a single mold box.

In one aspect, this invention is a mold assembly for use in producing wall blocks of different sizes having a horizontally oriented planar bottom member; first and second opposing and parallel side walls; and first and second opposing and parallel end walls, the side walls and end walls being joined to form an enclosed perimeter portion, the bottom member enclosing a bottom of the enclosed perimeter portion, a top of the enclosed perimeter portion being open. The mold assembly also has a planar division plate having a first end adjacent the first end wall and a second end adjacent the second end wall, the division plate being oriented in a perpendicular position with respect to the pallet and dividing the enclosed perimeter portion into first and second mold cavities, the division plate being positioned at an angle α with respect to the side walls, angle α being an acute angle greater than 0° such that each of the first and second mold cavities have parallel cavity end walls and non-parallel cavity side walls.

The mold assembly for use in producing wall blocks of different sizes may also have at least one mold liner connected to at least one of the side walls, end walls, and division plate. The enclosed perimeter of the mold may be square or rectangle and the first and second mold cavities may be the same size. Further, angle α of the division plate may be in the range of about 5° to 10°. In one embodiment angle α is 7.125°.

In another aspect, invention is a mold assembly for use in producing wall blocks of different sizes including a horizontally oriented planar bottom member; first and second opposing and parallel side walls; and first and second opposing and parallel end walls, the side walls and end walls being joined to form an enclosed perimeter portion, the bottom member enclosing a bottom of the enclosed perimeter portion, a top of the enclosed perimeter portion being open. The mold assembly also includes at least three planar division plates, each division plate having a first end adjacent the first end wall and a second end adjacent the second end wall, the division plates being oriented in a perpendicular position with respect to the pallet and dividing the enclosed perimeter portion into a plurality of elongate mold cavities, each mold cavity having opposing cavity end walls formed by the parallel end walls of the enclosed perimeter portion, at least two of the at least three division plates being positioned at an angle α with respect to the side walls, angle α being an acute angle greater than 0°, at least one of the at least three division plates being parallel to the side walls and being positioned between the at least two division plates positioned at an angle α such that each of the plurality of mold cavities have parallel cavity end walls and non-parallel cavity side walls.

The mold assembly for use in producing wall blocks of different sizes may also have at least one mold liner connected to at least one of the side walls, end walls, and division plate. The enclosed perimeter of the mold may be square or rectangle and the first and second mold cavities may be the same size. Further, angle α of the division plate may be in the range of about 5° to 10° and may specifically be 7.125°.

In another aspect, this invention is a method of making blocks of differing size by placing a mold over a horizontal pallet, the mold including first and second opposing and parallel side walls, and first and second opposing and parallel end walls, the side walls and end walls being joined to form an enclosed perimeter of the mold, the pallet enclosing a bottom of the enclosed perimeter portion, a top of the enclosed perimeter portion being open, the mold further including a planar division plate having a first end adjacent the first end wall and a second end adjacent the second end wall, the division plate being perpendicular to the pallet and dividing the enclosed perimeter portion into first and second mold cavities, the division plate being positioned at an angle α with respect to the side walls, angle α being an acute angle greater than 0° such that each of the first and second mold cavities have parallel cavity end walls and non-parallel cavity side walls. The method also includes filling the mold cavities with a moldable material to form a first slab in the first mold cavity and a second slab in the second mold cavity; applying downward pressure with a stripper head assembly to remove the first and second slabs from the mold; curing the first and second slabs; splitting the first slab into first and second blocks; and splitting the second slab into third and fourth blocks, each of the first, second, third and fourth blocks having opposing and parallel first and second face surfaces and opposing and non-parallel first and second side walls.

The method may also include having at least one mold liner connected to at least one of the side walls, end walls, and division plate. The enclosed perimeter of the mold may be square or rectangle and the first and second mold cavities may be the same size. Further, angle α of the division plate may be in the range of about 5° to 10°. In one embodiment angle α is 7.125°.

The method may further include having a distance between the face surfaces of each of the first, second, third and fourth blocks is the same and a distance between the side walls of each of the first, second, third and fourth blocks as measured along the first face surface is different.

### BRIEF DESCRIPTION OF THE DRAWINGS

A preferred form of the present invention will now be described by way of example with reference to the accompanying drawings, wherein:

FIG. 1A is a top plan view of a mold box of the present invention illustrating a first and a second mold cavity. FIG. 1B is a top plan view of the mold box of FIG. 1A illustrating a first and a second slab formed from the cavities.

FIG. 2A is a bottom plan view of the slab from the first cavity. FIG. 2B is a bottom plan view of a first block formed from the first cavity. FIG. 2C is a bottom plan view of a second block formed from the first cavity.

FIG. 3A is a bottom plan view of the slab produced from the second cavity of the mold box of FIG. 1A. FIG. 3B is a bottom plan view of a first block formed from the second cavity. FIG. 3C is a bottom plan view of a second block formed from the second cavity. FIG. 3D is a bottom view of the first block formed from the second cavity split along a split notch to form two separate blocks. FIG. 3E is a bottom view of the second block formed from the second cavity split along a split notch to produce two separate blocks.

FIG. 4A is a bottom plan view of first and second slabs formed from the first and second mold cavities of the mold box of FIG. 1A in accordance with an alternative embodiment of the present invention. FIGS. 4B and 4C are bottom views of blocks formed from the second slab of the second mold cavity. FIG. 4D is a bottom view of blocks formed from the second slab of the second mold cavity.

FIG. 5A is a top plan view of a second mold box illustrating a first and second cavity according to an alternative embodiment of the present invention. FIG. 5B is a top plan view of the mold box of FIG. 5A illustrating a first and second slab formed from the cavities.

FIG. 6A is a top plan view of a third mold box illustrating first, second, third and fourth cavities according to a further alternative embodiment of the present invention. FIG. 6B is a top plan view of the mold box of FIG. 6A illustrating first, second, third and fourth slab formed from the cavities.

FIG. 7A is a top view of a layout of a course of blocks in a first column made from blocks formed from the slabs of FIG. 4A. FIG. 7B is front view of the first column constructed from the blocks of the present invention. FIG. 7C is a top view of a layout of a course of blocks in a second column made from blocks produced from the slabs of FIG. 4A. FIG. 7D is front view of the second column constructed from the blocks of the present invention. FIG. 7E is a top view of a first layer of a column and wall (pilaster) formed from the blocks of the present invention. FIG. 7F is a top view of a second layer of the pilaster formed from the blocks of the present invention.

FIG. 8 is a perspective view of a wall with a 90 degree corner constructed from the wall blocks of the present invention.

FIG. 9A is a cross-sectional side view of a retaining wall with no setback constructed with the wall blocks of the present invention. FIG. 9B is a cross-sectional side view of a retaining wall with setback constructed with the wall blocks of the present invention.

FIGS. 10A and 10B are perspective views of a portion of a second wall produced with the blocks of the present invention.

FIGS. 11A to 11C are top views of a layer of blocks of a closed convex wall, an open concave wall and an open linear wall, respectively.

### DETAILED DESCRIPTION OF THE PREFERRED EMBODIMENTS

The present invention is a mold box and method of manufacture of wall blocks with the mold box. The invention further includes the construction of walls and columns with blocks made in accordance with the invention. The mold box is used to form multiple blocks at one time. In this description the terms “mold” and “mold box” may be used interchangeably. The mold and a lower plate (production pallet) form a cavity for the formation of blocks. Moldable material is placed into the mold and allowed to set for a time sufficient to allow retention of block shape when the mold is removed. In a manufacturing process, it is desirable to use one mold to form many blocks. Thus, the product (first set of blocks or slabs) is removed from the mold and the product is moved to a curing station while resting on its production pallet. Another production pallet is positioned under the mold to receive the moldable material which again fills the mold. In this way, many sets of multiple blocks are formed with one mold and many lower plates (production pallets).

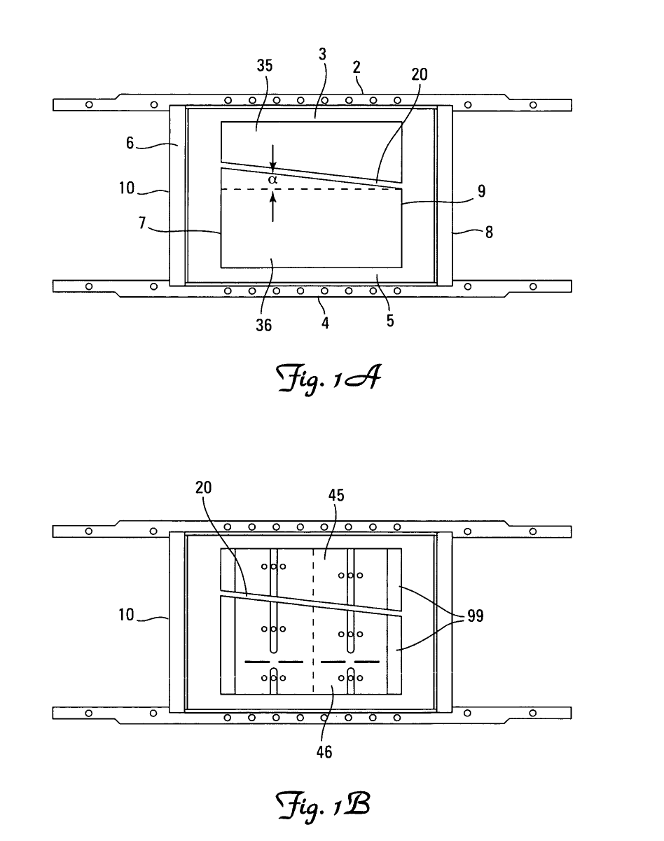

Referring to FIGS. 1A and 1B, there can be seen a multi-block mold box 10 according to an embodiment of the present invention. Mold box 10 generally includes opposing first and second side frame walls 2 and 4 and opposing first and second end frame walls 6 and 8. Mold box 10 may also include side space liners 3 and 5 and end space liners 7 and 9. The space between the mold box frame walls and liners is either covered or comprises a solid material to ensure that material entering the mold box cannot be captured between the frames and liners. As known in the art the side and end space liners may be separate parts bolted or affixed to the side and/or end frame walls. Though mold box 10 may have various dimensions, typical dimensions of this mold box are about 18.5 inches (47.0 cm) wide (i.e., the width of both the first and second end walls), 26.0 inches (66.0 cm) long (i.e., the length of both the first and second side walls), and 4 inches (10.2 cm) thick.

Division plate 20 spans end walls 6 and 8 of mold box 10. The ends of division plate 20 may be securely or removeably fixed to end walls 6 and 8 in a conventional manner. The division plate is of conventional design except that instead of being parallel to the mold box side frame walls 2 and 4 it is angled. The angled division plate enables blocks of different sizes and shapes to be produced in a single mold box. These multi-sized, multi-shaped blocks may be fit together as a system of walls, columns, pilasters and the like. Division plate 20 is preferably positioned at an angle α in the range of 5° to 10°. For example angle α may equal 7.125°, which keeps the tangent length of the angle very similar to the perpendicular width of a block end. However, this angle can be changed to vary the shape of the blocks produced in the mold box as desired. The location of division plate 20 closer to side frame 2 than to side frame 4 defines first and second mold cavities 35 and 36 of different sizes. Mold cavities 35 and 36 form slabs 45 and 46 with identical heights and widths, but differing lengths. As described hereafter slabs 45 and 46 are each split after removal from the mold to produce blocks of four different sizes can be produced. Two of those blocks can be site split to produce two further blocks and one of the two blocks that can be split may be split again to produce three blocks depending upon the desired application. Alternatively, each mold cavity could be used to produce a single block such that two blocks of different size would be produced in the mold. It should be further noted that the division plate can be affixed to the mold at varying locations along the end walls to change the size of the slabs produced in the mold as so desired, an example being evenly sized cavities separated by the angled division plate.

The mold box end frame walls 6 and 8 and side frame walls 2 and 4, as well as the division plate 20 may be modified by including liners that define the shape of the block being cast in each mold cavity and as such could be provided with a roughened exterior that imparts a textured surface to a portion of the block as it is being stripped from the mold.

As with conventional mold boxes, the mold box and division plate of the present invention are configured to rest upon a pallet to form cavities 35 and 36. Masonry material is deposited into cavities 35 and 36 and later removed by stripper shoes on a head assembly that contact the masonry material from above, compress it, and then push it through the mold while the mold is held firmly in a stationary position in the mold machine in accordance with procedures well known to those of skill in the art. The masonry material typically is a rugged, weather resistant material, preferably (and typically) zero-slump molded concrete. Other suitable materials include wet cast concrete, plastic, reinforced fibers, wood, metal and stone. A vibratory action and stripper shoes on the mold head assembly can compress the material contained within the mold cavities without touching mold liners, division plates or division plate liners. The blocks are formed in the mold box with their bottom surfaces facing upward.

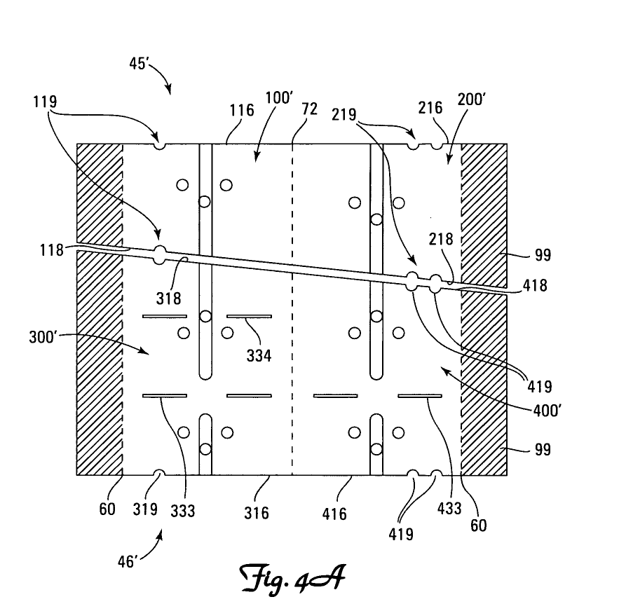

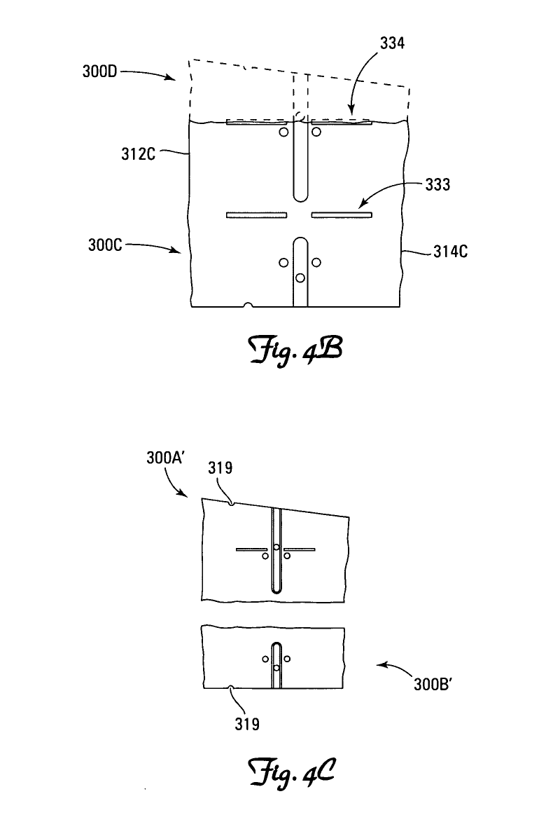

Pin holes or pin receiving apertures are formed by core parts that are, for example, attached to core bars positioned above the mold box or are attached to the sidewalls or liners of the mold box. The core parts hang in the mold cavities and preferably extend through the height of the cavity. The core parts may be positioned at desired locations. Channels in the blocks are formed by using a spanning beam that is fastened on each end to the sidewalls/liners of the mold cavity as known in the art. Notches, or score lines, which allow the blocks to be split in the field are formed by a projection on the bottom of the head of the stripper shoe. During the block making process masonry material is poured into the mold box and forms around the core parts and spanning beam (core bar). When the block is stripped away from the mold cavity the pin receiving apertures and the channels are formed into the block. Variously dimensioned pin receiving apertures and channels can be made in this manner. Grooves as disclosed in FIG. 4A may be formed from liners or with core parts with the masonry material forming around it as discussed above.

The pin receiving apertures and channels are used to form an attachment system among the blocks in the wall. Any number of apertures may be used. In the disclosed embodiments there are one or two sets of three pin holes formed into the block. These pin holes or apertures may be formed into the block in a line perpendicular to the first and second faces and may be equidistant from one another. These apertures may also be offset which helps prevent crumbs of concrete from tumbling down the open holes after the molding process. The positioning of the apertures permits the alignment of blocks directly over one another or either forward or backward relative to one another so that vertical or non-vertical walls may be constructed.

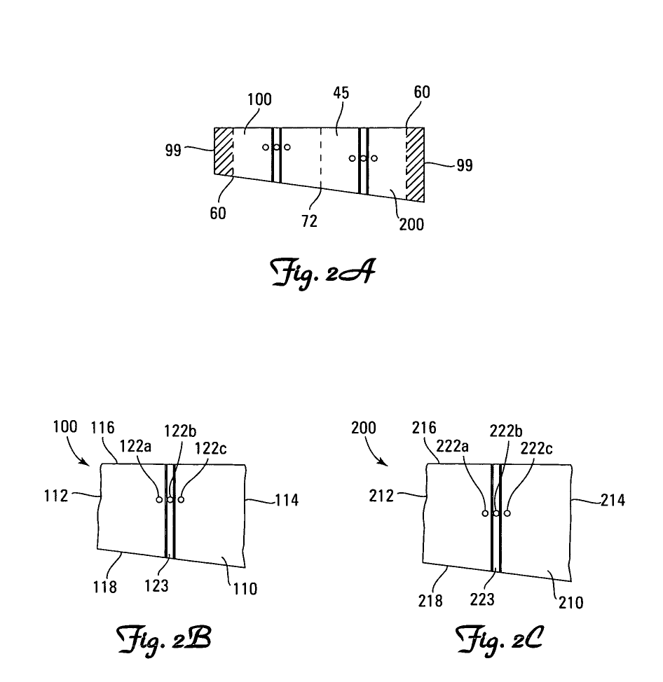

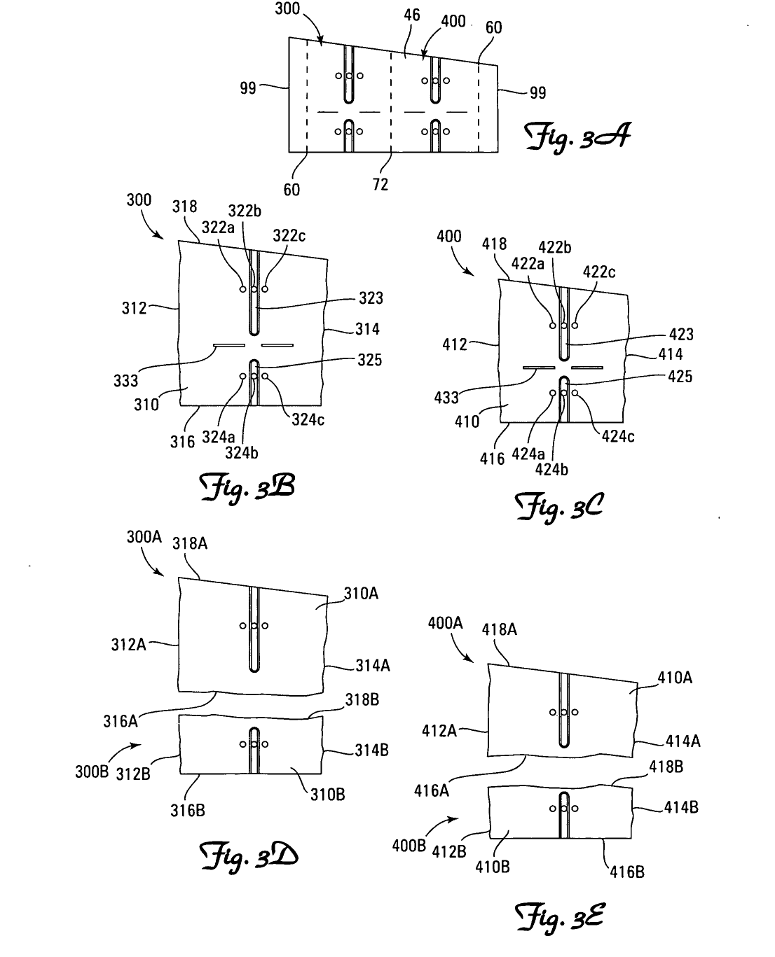

FIGS. 2A and 3A illustrates slabs 45 and 46 produced from mold box 10 of the present invention. The slabs (and the blocks made from them) are formed bottom side (lower surface) up in the mold box. FIG. 2A depicts slab 45 formed in mold cavity 35 according to an embodiment of the present invention. Slab 45 is a double unit, meaning that slab 45 comprises two, joined wall blocks 100 and 200. The material shown in hatch marks is waste material 99 and is split away from the slab at outboard split lines 60 forming textured sides. Center split line 72 shown in dashed defines the boundary where slab 45 can be split to form two wall blocks 100 and 200 as shown in bottom plan view in FIGS. 2B and 2C.

Block 100, as shown in FIG. 2B, comprises an upper surface opposed to and substantially parallel to a lower surface 110. The upper surface is separated from lower surface 110 by the thickness of the block. First and second opposed faces 112 and 114 are substantially parallel. Second face 114 has a greater surface area than first face 112. First face 112 and second face 114 are joined by and orthogonal to first side surface 116. That is, the angle formed by an imaginary line coincident with first face 112 and an imaginary line coincident with first side surface 116 is 90 degrees. First face 112 and second face 114 also are joined to second side surface 118. Side surface 116 and 118 are opposed and are non-parallel. Similarly, the angle formed between second face 114 and first side surface 116 is 90 degrees. The angles formed between either of the first and second faces and side surface 118 are non-orthogonal. That is, one angle will be acute and one will be obtuse. The block is provided with aligned pin-receiving apertures 122a, 122b, and 122c. Alternatively, the pin receiving apertures may be offset as described hereafter in connection with FIGS. 4A and 4B. The lower surface of the block is provided with channel 123 that is in a line coincident with the center aperture (122b) of the set of three pin-receiving apertures and parallel to first and second faces 112 and 114 of the block. Channel 123 has a depth and a profile sufficient to permit the use of pins having a shoulder or lip to be used in the pin-receiving apertures. Thus, for example, during construction of a wall the shaft of a shouldered pin is inserted from the top surface of a block into a pin-receiving aperture. The shouldered portion which is larger than the aperture extends from the top surface of the block and may be received in a channel in the lower surface of a block in the next course of blocks. The sets of three pin-receiving aperture locations in the block give it versatility in terms of their use to make a near vertical wall using the center aperture or a wall having a setback by using one of the outboard apertures (122a or 122c) depending on which face of the block (112 or 114) is oriented outwardly in the wall. Channel 123 spans at least a portion of the length of the block. Though block 100 may have various dimensions, typical dimensions of this block are about 8 inches (20.3 cm) wide (i.e., the width of side surface 116), 6 inches (15.2 cm) long (i.e., the length of second face 114), 5 inches (12.7 cm) long (i.e., the length of first face 112) and 4 inches (10.2 cm) thick (i.e., the thickness between the opposing upper and lower surface). Persons having skill in the art of concrete wall block manufacture will recognize that any number of textures can be imparted on the surfaces of the slabs that are split without departing from the spirit and scope of the present invention.

FIG. 2C illustrates block 200 and comprises an upper surface opposed to and substantially parallel to lower surface 210. The upper surface is separated from lower surface 210 by the thickness of the block. First and second opposed faces 212 and 214 are substantially parallel. Second face 214 has a greater surface area than first face 212. First face 212 and second face 214 are joined by and orthogonal to first side surface 216. That is, the angle formed by an imaginary line coincident with first face 212 and an imaginary line coincident with first side surface 216 is 90 degrees. First face 212 and second face 214 also are joined to second side surface 218. Side surface 216 and 218 are opposed and are non-parallel. Similarly, the angle formed between second face 214 and first side surface 216 is 90 degrees. The angles formed between either of the first and second faces and side surface 218 are non-orthogonal. That is, one angle will be acute and one will be obtuse. The block is provided with pin-receiving apertures 222a, 222b, and 222c. The lower surface of the block is provided with channel 223 that is in a line coincident with the center aperture (222b) of the three pin-receiving apertures and parallel to first and second faces 212 and 214 of the block. Channel 223 spans at least a portion of the length of the block. Persons having skill in the art of concrete wall block manufacture will recognize that any number of textures can be imparted on the surfaces of the slab that are split without departing from the spirit and scope of the present invention. Block 200 is substantially similar to block 100 except that the lengths of faces 212 and 214 are greater than the lengths of first and second faces 112 and 114 of block 100, respectively. Note that the lengths of faces 114 and 212 are equal since they were formed along common split line 72. This difference in face length (and block size) is caused by the angled division plate 20 of mold box 10. Though block 200 may have various dimensions, typical dimensions of this block are about 8 inches (20.3 cm) wide (i.e., the width of side surface 216), 7 inches (17.8 cm) long (i.e., the length of second face 214), 6 inches (15.2 cm) long (i.e., the length of first face 212) and 4 inches (10.2 cm) thick (i.e., the thickness between the opposing upper and lower surface).

FIG. 3A depicts slab 46 formed in a mold cavity 36 of FIG. 1A according to an embodiment of the present invention. Slab 46 is a double unit, meaning that slab 46 comprises two, joined wall blocks 300 and 400. The material shown in hatch marks is waste material 99 and is split away from the slab at the outboard split lines 60 forming textured sides. Center split line 72 shown in dashed defines the boundary where slab 46 can be split to form the two wall blocks 300 and 400 as shown in FIGS. 3B and 3C. The center split also results in textured sides on the block where the split occurred.

FIG. 3B illustrates block 300 comprising an upper surface which is opposed to and substantially parallel to lower surface 310. The upper surface is separated from lower surface 310 by the thickness of the block. First and second opposed faces 312 and 314 are substantially parallel. First face 312 has a greater surface area than second face 314. First face 312 and second face 314 are joined by and orthogonal to first side surface 316. That is, the angle formed by an imaginary line coincident with first face 312 and an imaginary line coincident with first side surface 316 is 90 degrees. First face 312 and second face 314 also are joined to second side surface 318. Side surface 316 and 318 are opposed and are non-parallel. Similarly, the angle formed between second face 314 and first side surface 316 is 90 degrees. The angles formed between either of the first and second faces and side surface 318 are non-orthogonal. That is, one angle will be acute and one will be obtuse. The block is provided with pin-receiving apertures 322a, 322b, 322c, 324a, 324b and 324c. The lower surface of the block is provided with channel 323 and 325 that is in a line coincident with the center apertures (322b and 324b) of the three pin-receiving apertures and parallel to first and second faces 312 and 314 of the block. Channels 323 and 325 have a depth and a profile sufficient to permit the use of pins having a shoulder or lip to be used in the pin-receiving apertures. Channels 323 and 325 span at least a portion of the length of the block. Though block 300 may have various dimensions, typical dimensions of this block are about 8 inches (20.3 cm) wide (i.e., the width of side surface 316), 11 inches (27.9 cm) long (i.e., the length of first face 312), 10 inches (25.4 cm) long (i.e., the length of second face 314) and 4 inches (10.2 cm) thick (i.e., the thickness between the opposing upper and lower surface). In some circumstances as described below it is desirable to split block 300 into two separate blocks. Lateral split notch 333 defines the boundary where block 300 can be field split to produce two separate wall blocks 300A and 300B respectively.

FIG. 3D illustrates blocks 300A and 300B after they have been split. Block 300A is substantially similar in size and shape to wall block 200 with the exception of side 316A being textured because of the splitting of the block at split notch 333. Thus, the features of block 200 described above are also applicable to block 300A.

Block 300B, as illustrated in FIG. 3D, is substantially rectangular and comprises an upper surface which is opposed to and substantially parallel to lower surface 310B. The upper surface is separated from lower surface 310B by the thickness of the block. First and second opposed faces 312B and 314B are substantially parallel. Side surface 316B and 318B are opposed and are substantially parallel. The block is provided with pin-receiving apertures 324a, 324b, and 324c. The lower surface of the block is provided with channel 325 that is in a line coincident with the center aperture (324b) of the set of three pin-receiving apertures and parallel to first and second faces 312B and 314B of the block. Though block 300B may have various dimensions, typical dimensions of this block are about 8 inches (20.3 cm) wide (i.e., the width of side surface 316B), 4 inches (10.2 cm) long (i.e., the length of both the first and second faces), and 4 inches (10.2 cm) thick (i.e., the thickness between the opposing upper and lower surface).

FIG. 3C shows block 400 comprising an upper surface opposed to and substantially parallel to lower surface 410. The upper surface is separated from surface 410 by the thickness of the block. First and second opposed faces 412 and 414 are substantially parallel. First face 412 has a greater surface area than second face 414. First face 412 and second face 414 are joined by and orthogonal to first side surface 416. That is, the angle formed by an imaginary line coincident with first face 412 and an imaginary line coincident with first side surface 416 is 90 degrees. First face 412 and second face 414 also are joined to second side surface 418. Side surface 416 and 418 are opposed and are non-parallel. Similarly, the angle formed between second face 414 and first side surface 416 is 90 degrees. The angles formed between either of the first and second faces and side surface 418 are non-orthogonal. That is, one angle will be acute and one will be obtuse. The block is provided with pin-receiving apertures 422a, 422b, 422c, 424a, 424b and 424c. The lower surface of the block is provided with channels 423 and 425 that are in a line coincident with the center apertures (422b and 424b) of the set of three pin-receiving apertures and parallel to first and second faces 312 and 314 of the block. Channels 423 and 425 have a depth and a profile sufficient to permit the use of pins having a shoulder or lip to be used in the pin-receiving apertures. Channel 423 and 425 span at least a portion of the length of the block. Wall block 400 is substantially similar to wall block 300 with the exception that the length of faces 412 and 414 are less than the first and second faces 312 and 314, respectively, of block 300 due to cavity 36 formed by the angled division plate 20 of mold box 10. Though block 400 may have various dimensions, typical dimensions of this block are about 8 inches (20.3 cm) wide (i.e., the width of side surface 416), 10 inches (25.4 cm) long (i.e., the length of first face 412), 9 inches (22.9 cm) long (i.e., the length of second face 414) and 4 inches (10.2 cm) thick (i.e., the thickness between the opposing upper and lower surface). As with block 300, block 400 can be split into separate blocks. Lateral split notch 433 defines the boundary where blocks 400 can be split to produce two separate wall blocks 400A and 400B respectively.

Block 400A, shown in FIG. 3E, is substantially similar in size and shape to wall block 100 with the exception of side 416A being textured because of the splitting of the block at split notch 433. Thus, the features of block 100 described above are also applicable to block 400A.

Block 400B, shown in FIG. 3E, comprises an upper surface opposed to and substantially parallel to lower surface 410B. The upper surface is separated from lower surface 410B by the thickness of the block. First and second opposed faces 412B and 414B are substantially parallel. Side surface 416B and 418B are opposed and are substantially parallel. The block is provided with pin-receiving apertures 424a, 424b, and 424c. The lower surface of the block is provided with channel 425 that is in a line coincident with the center aperture (424b) of the three pin-receiving apertures and parallel to first and second faces 412B and 414B of the block. Wall block 400B is substantially similar in size and shape to wall block 300B.

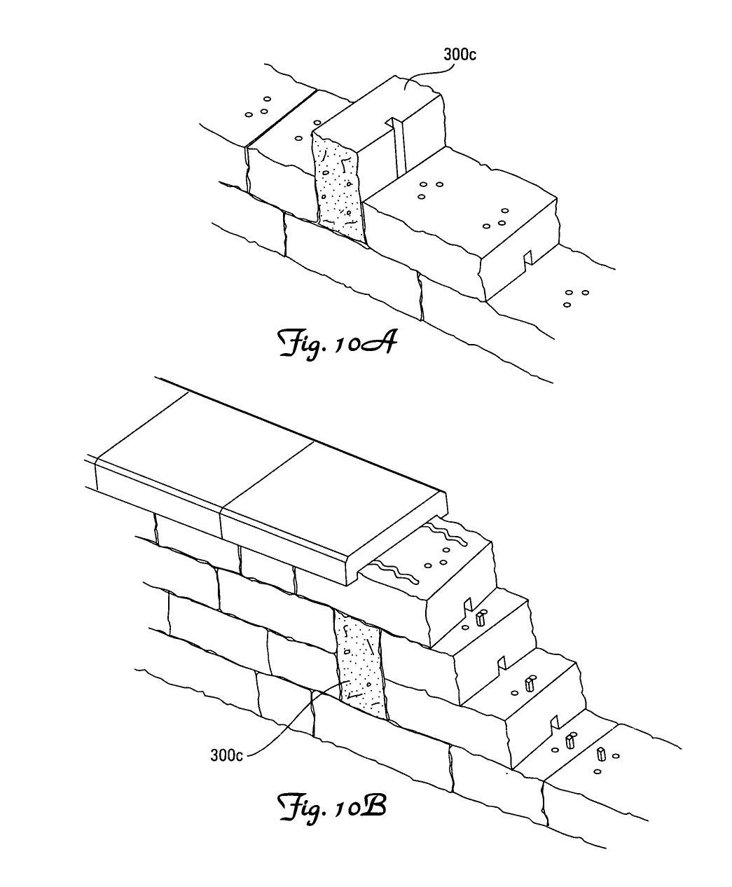

FIG. 4A depicts slabs 45′ and 46′ formed in a mold which is substantially similar to mold 10. Slabs 45′ and 46′ are substantially similar to slabs 45 and 46 of FIGS. 1B, 2A and 3A except as noted. Therefore, the same reference numerals are used to identify similar parts. Like slabs 45 and 46 slabs 45′ and 46′ are double units, meaning the slabs comprise two joined wall blocks. Slab 45′ produces wall blocks 100′ and 200′ and slab 46′ produces wall blocks 300′ and 400′. The material shown in hatch marks is waste material 99 and is split away from the slab at the outboard split lines 60 forming textured sides. Center split line 72 shown in dashed defines the boundary where slabs 45′ and 46′ can be split to form wall blocks 100′, 200′ 300′ and 400′. Wall block 100′ is substantially similar to wall block 100 except that side surfaces 116 and 118 have each been provided with groove 119. The groove helps in building a column to match up the correct set of blocks in an aesthetically pleasing and functional arrangement and also helps in re-cubing after tumbling as is discussed further below. Wall block 200′ is substantially similar to wall block 200 except that side surfaces 216 and 218 have each been provided with two grooves 219. Wall block 300′ is substantially similar to wall block 300 except that side surfaces 316 and 318 have been provided with groove 319 and block 300′ has two separate split notches 333 and 334. Lateral split notches 333 and 334 define the boundaries where block 300′ can be field split to produce separate wall blocks. FIG. 4B illustrates blocks 300C and 300D produced by a field split of block 300′ at notch 334. Block 300C can be used in the wall system of the present invention with the first or second face 312C or 314C placed vertically in the wall to give the wall a more natural and random appearance as shown in FIG. 10. FIG. 4C illustrates blocks 300A′ and 300B′ produced by a field split of block 300′ at notch 333. Blocks 300A′ and 300B′ have a size, shape and function similar to blocks 300A and 300B, respectively. Wall block 400′ is substantially similar to wall block 400 except that side surfaces 416 and 418 have been provided with grooves 419. Block 400′ can be field split at notch 433 to produce two separate wall blocks 400A′ and 400B′ which are similar to blocks 400A and 400B. FIG. 4D illustrates blocks 300B′, 300D and 300E produced by a field split of block 300′ at notch 333 and notch 334. Block 300E is substantially similar to wall block 300B′ but since it is field split on both ends, it has a natural textured appearance on all four sides of the block.

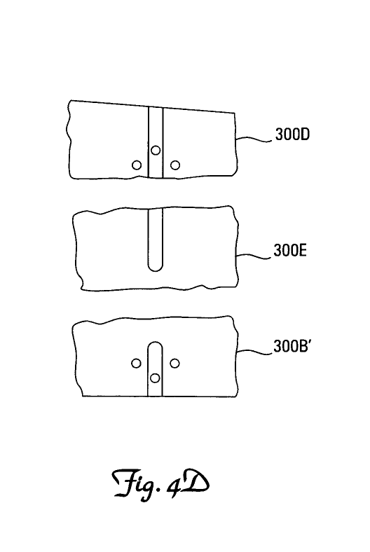

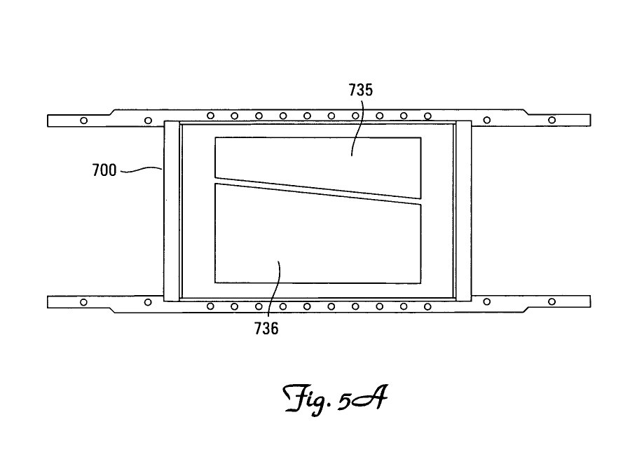

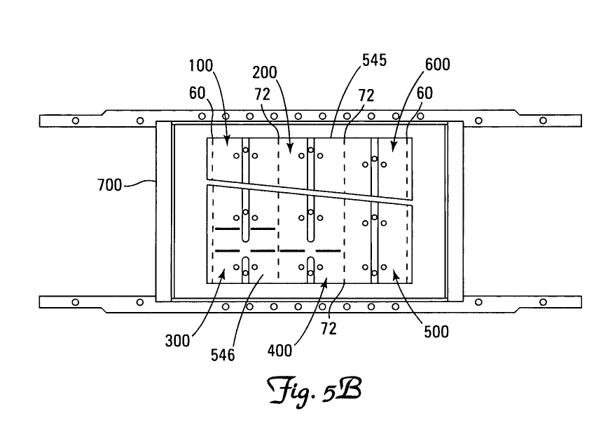

FIG. 5A illustrates an alternate multi-block mold box 700 of the present invention. Mold box 700 is substantially similar to mold box 10 except that it is longer. For example, mold box 700 may be 34.5 inches (87.6 cm) long (i.e., the length of both the first and second side walls). Lengthening the mold box results in the formation of longer mold cavities 735 and 736. Other than length mold box 700 is the same as mold box 10 and the description of parts and features is the same as for FIG. 1A except with respect to the slabs formed in mold box 700.

Slabs 545 and 546 formed in mold cavities 735 and 736 are triple units, meaning the slabs comprise three joined wall blocks. Slab 545 produces wall blocks 100, 200 and 500 and slab 546 produces wall blocks 300, 400 and 600. The material shown in hatch marks is waste material 99 and is split away from the slab at the outboard split lines 60 forming textured sides in the same manner described in connection with FIG. 1B. Center split lines 72 shown as dashed lines define the boundary where slabs 545 and 546 can be split to form wall blocks 100, 200, 300, 400, 500 and 600. These blocks can be provided with split lines, split notches, channels, grooves, and apertures as desired and as described above. Blocks 100, 200, 300 and 400 have been described above.

Though block 500 may have various dimensions, typical dimensions of this block are about 8 inches (20.3 cm) wide (i.e., the width of side surface 416), 9 inches (22.9 cm) long (i.e., the length of a first face), 8 inches (20.3 cm) long (i.e., the length of a second face) and 4 inches (10.2 cm) thick (i.e., the thickness between the opposing upper and lower surface).

Wall block 600 is substantial similar to wall block 500 with the exception that the lengths of its first and second faces are less than the first and second faces of block 500, respectively. Though block 600 may have various dimensions, typical dimensions of this block are about 8 inches (20.3 cm) wide (i.e., the width of side surface 416), 8 inches (20.3 cm) long (i.e., the length of a first face), 7 inches (17.8 cm) long (i.e., the length of a second face) and 4 inches (10.2 cm) thick (i.e., the thickness between the opposing upper and lower surface).

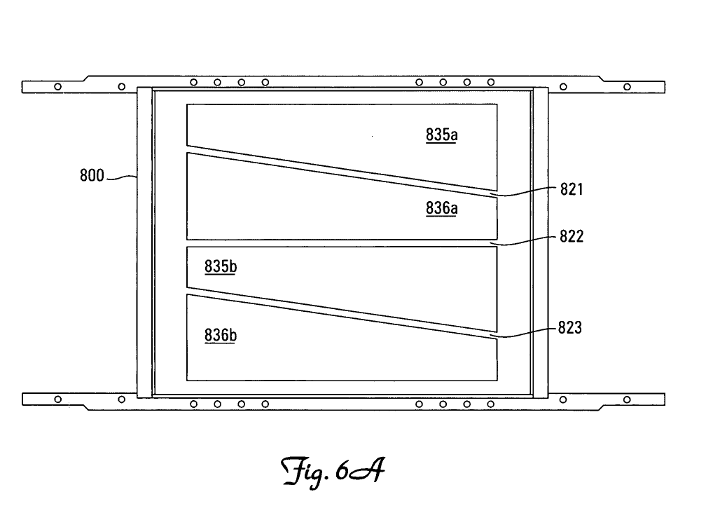

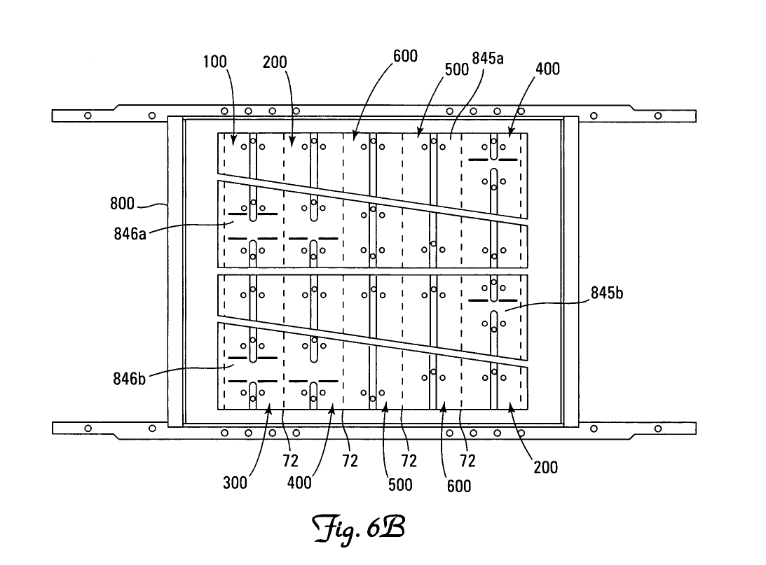

FIG. 6A illustrates a further embodiment of a multi-block mold box 800 of the present invention. Mold box 800 is substantially similar to mold box 10 except that it is wider and longer. Typical dimensions of this mold box are about 38.0 inches (96.5 cm) wide (i.e., the width of both the first and second end walls), 52.0 inches (132.1 cm) long (i.e., the length of both the first and second side walls), and 4 inches (10.2 cm) thick. Angled division plates 821 and 823 along with division plate 8ss which is perpendicular to the end walls and parallel to the side walls, defines first 835a, second 836a, third 835b, and fourth 836b mold cavities with cavities 835a and 835b being of similar size and cavities 836a and 836b being of similar size as shown in FIG. 6B. Mold cavities 835a, 835b, 836a, and 836b form slabs 845a, 845b, 846a and 846b.

Slabs 845a, 845b, 846a and 846b formed in a mold box 800 are quintuple units, meaning the slabs comprise five joined wall blocks. Slabs 845a and 845b produce wall blocks 100, 200, 400, 500 and 600 and slabs 846a and 846b produce wall blocks 200, 300, 400, 500 and 600. The material shown in hatch marks is waste material 99 and is split away from the slab at the outboard split lines forming textured sides. Center split lines 72 shown as dashed lines define the boundary where slabs 845a, 845b, 846a and 846b can be split to form wall blocks 100, 200, 300 400, 500 and 600. These blocks can be provided with split lines, split notches, channels, grooves and apertures as desired and as described above.

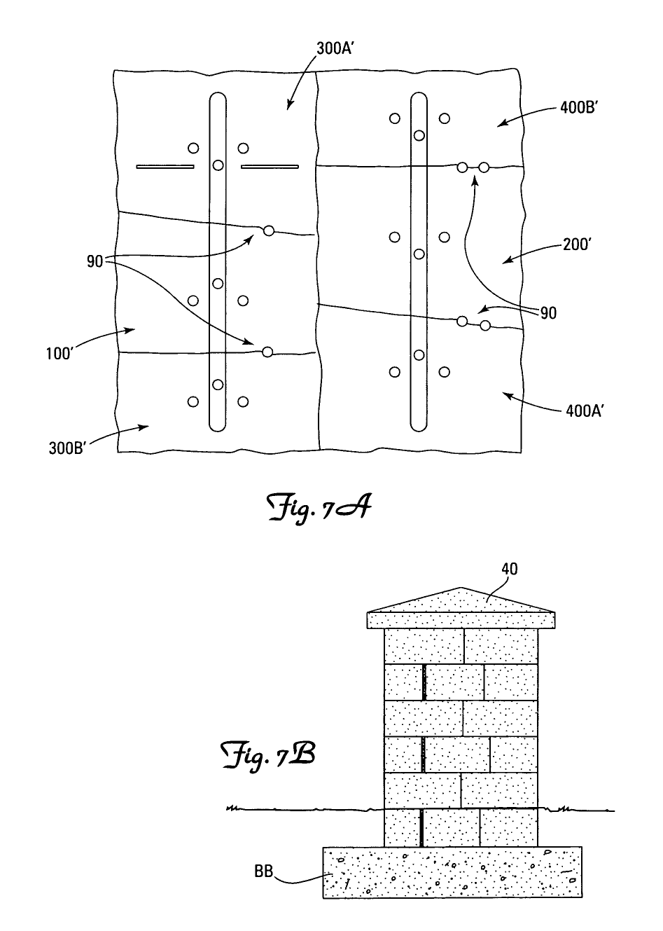

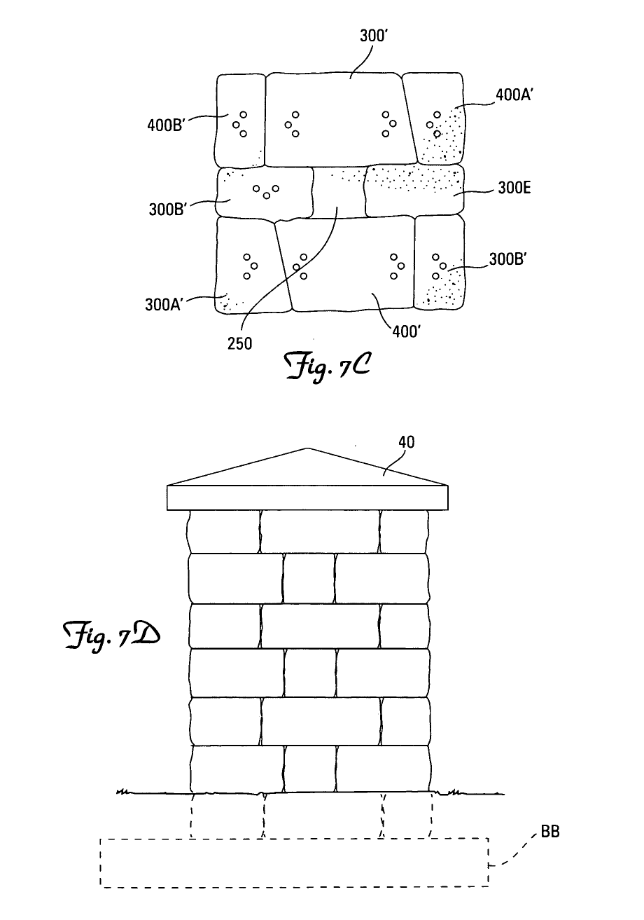

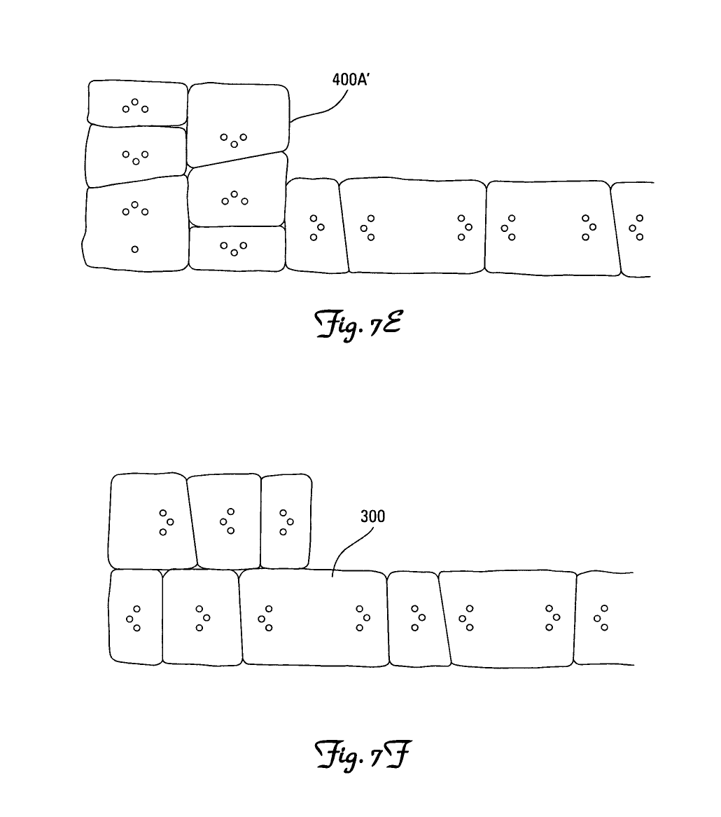

FIGS. 7A and 7B illustrate a column made with the multiple blocks of FIGS. 4A, 4B and 4C. It will be appreciated, however, that the column could be made with the blocks of FIG. 2B, 2C, 3B, 3C, 3D, 3E, 5B or 6B. In constructing such a column a trench is dug and leveling pad BB is laid in the trench. A first course of blocks is laid on top of the leveling pad. Both the leveling pad and first course of blocks may be installed below grade if desired. Leveling pad BB comprises compacted free draining granular road base material such as crushed stone or concrete. The leveling pad creates a level and somewhat flexible wall support base and eliminates the need to trench to a depth that would resist frost. The leveling pad can move as the ground freezes if necessary. Construction adhesive can be used in between courses to hold the courses of blocks in place.

FIG. 7A shows the layout of a single course of blocks used in the column. Blocks 300′ and 400′ have been field split at notch 333′ and 433′ to produce blocks 300A′, 300B′, 400A′ and 400B′ and which are substantially similar to 300A, 300B, 400A and 400B and ensure a weathered, natural appearance on every corner and thus every side of the column. That is, both a front face and a side face are visible in this column at the corner and both have a weathered, natural, appearance because of the field split of blocks 300′ and 400′. Groove 119 from side face 118 of block 100′ aligns with groove 319 of side face 318 of Block 300A to form alignment hole 90 and groove 119 from side face 116 of block 100′ aligns with groove 319 of side face 316 of block 300B′ to form alignment hole 90. Grooves 219 from side face 218 of block 200′ aligns with grooves 419 of side face 418 of block 400A to form alignment holes 90 and grooves 219 from side face 216 of block 200′ aligns with grooves 419 of side face 416 of block 400B′ to form alignment holes 90. The alignment holes form a visual alignment configuration to ensure proper placement of blocks and helps to make for easier installation. This double groove system provides greater ease of installation because it is easier to determine where each block is placed in a course. The layout shown in FIG. 7A is rotated 90 degrees and used as the pattern for each successive course, contributing to the random natural appearance of the wall. It will be apparent that since the column is formed by rotating the block pattern 90° for each successive course the column is square. The square has a dimension equal to twice the width of the blocks on two sides which in the embodiment shown in FIG. 7A is 16 inches. The other opposing sides of each course in the column comprise the combined side lengths of three of the blocks. By using blocks of this configuration and by rotating the courses 90° an aesthetically pleasing block pattern is obtained which avoids the appearance of a stacked bond pattern. Capping block 40 is used to finish off the column.

FIGS. 7C and 7D illustrate a column made with the multiple blocks of FIGS. 4A to 4C. The blocks have been shown without the groove and alignment system of the blocks produced from FIG. 4A as in the blocks of FIGS. 2B, 2C, 3B, 3C, 3D and 3E to show yet a different embodiment of blocks and it should be appreciated that the column could be made with the blocks of FIGS. 2B, 2C, 3B, 3C, 3D, 3E, 5B and 6B and with the groove and alignment system. In constructing such a column a trench is dug and leveling pad BB is laid in the trench. A first course of blocks is laid on top of the leveling pad. Both the leveling pad and first course of blocks may be installed below grade if desired. Blocks 300′ and 400′ have been field split at notch 333′ and 433′ to produce blocks 300A′, 300B′, 400A′ and 400B′ and which are substantially similar to 300A, 300B, 400A and 400B and ensure a weathered, natural appearance on every corner and thus every side of the column. That is, both a front face and a side face are visible in this column at the corner and both have a weathered, natural, appearance because of the field split of blocks 300′ and 400′. Additionally as second block 300′ has been filed split at both notch 333 and 334 to produce block 300B and 300E. The layout shown in FIG. 7C is rotated 90 degrees and used as the pattern for each successive course, contributing to the random natural appearance of the wall. It will be apparent that since the column is formed by rotating the block pattern 90° for each successive course the column is square. It should be noted that the layouts as shown in the drawings are not limiting and that various other patterns and sizes of columns can be produced with the blocks of the present invention. Column core 250 creates a vertical columnar cavity through the center of the column and can be used to further reinforce the column with vertical reinforcing members such as steel rebar and may then be filled with concrete grout. Central core 250 may also be used as a corridor for supplying electricity to the column if so desired.

FIGS. 7E and 7F illustrate top views in courses of a column and a wall (pilaster). FIG. 7E shows the column with the same layout as a course of blocks as in FIG. 7A. FIG. 7F shows the column rotated 90° degrees and with a layout similar to the layout of FIG. 7E except block 300 is used as a bridge to connect the wall and column together and replaces block 400A′ of the course as shown in FIGS. 7A and 7E. Block 300 additionally contributes to the random natural appearance of the wall and column while providing interconnectivity and additional support to the wall and column structure (pilaster). It should be noted that block 300 could be substituted for any block with a larger front face surface area than block 400A′ which it is replacing. Additionally it should be noted that any or all courses of the columns could be provided with a connector bridge as in 7F to interconnect the column and wall further.

FIG. 8 illustrates a prospective view of a wall illustrating how a wall with a 90° corner can be made from the multiple blocks of this invention. The first course of blocks AA of such a wall is typically laid in a trench and successive courses are laid one on top of the other. The straightness of the wall is formed by placing an angled end of one block directly next to the inverse angled end of second adjacent block. The straight end of a block is placed next to a straight end of a second adjacent block. This alternation of straight to straight and angled to angled ends also increases the overall random appearance of the placement of the blocks of the wall. Pins can be used in the pin-receiving aperture to hold the courses of blocks in place, although in some applications where the wall design is simple, the weight of the blocks is sufficient to hold the blocks in place. In this illustration, blocks 100, 200, 300 and 400, each having a different width, are used to form a wall having a front surface and a rear surface. Both the first and the second face of any one block may be used to form the front surface of the wall. The first and second faces of one block also are different in surface area. These features contribute to the random, natural appearance of the wall. An advantage of the block of this invention is that the as-manufactured block can be used in a wall having corners without any further surface treatment of the block. That is, block 300 and 400 may be field split at notch 333 and 433 to produce both a front face and a side face with a weathered, natural, appearance at the corner of the wall (i.e. corner block 300B). Because the blocks of this invention have one angled side, the blocks may be used to form 90 degree corners. A random appearance of the wall is achievable since all sizes of blocks may be used anywhere in a wall. A cap or finish layer 30 is shown in partial view at the top of the wall.

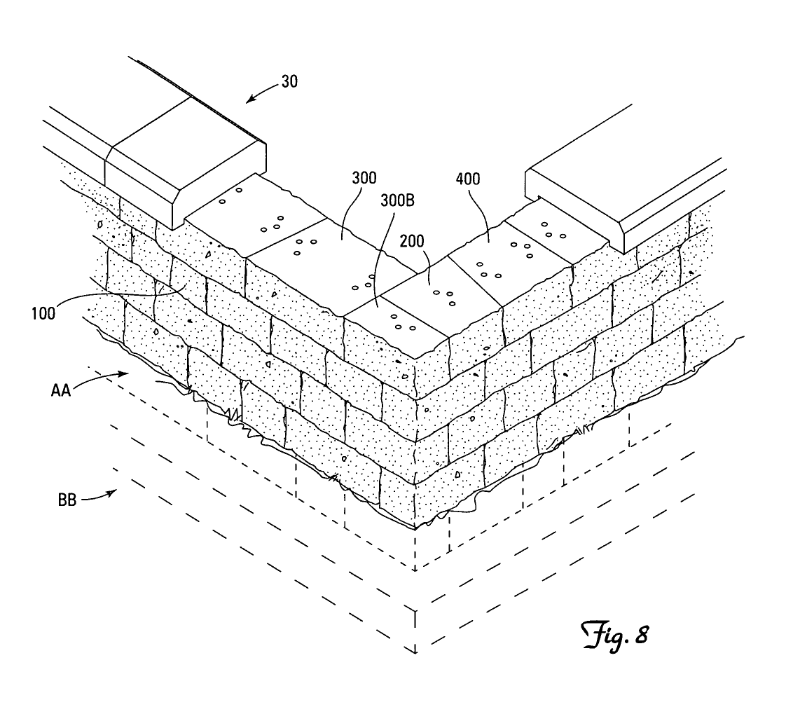

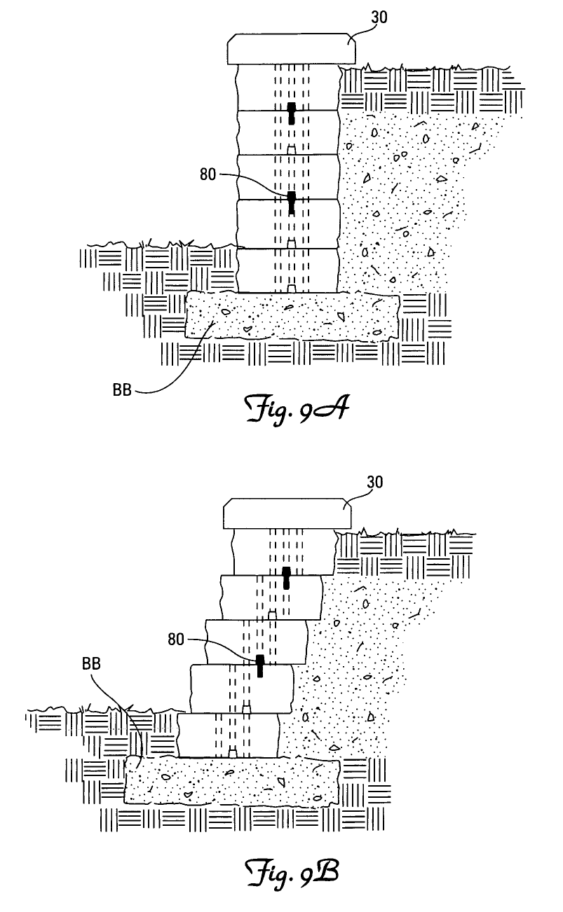

FIG. 9A is a side view of a type of retaining wall in which the blocks of an upper course are stacked directly on top of the blocks of a lower course, resulting in a wall that is substantially vertical. Leveling pad BB and the first course of blocks are installed below grade. The wall is finished or capped, with cap layer 30. FIG. 9A illustrates a conventional retaining wall in which the retained soil is level with the top of the wall.

FIG. 9B is a side view of another type of retaining wall in which the blocks of an upper course are set back from the blocks of a lower course, resulting in a wall that is set back or angled from vertical. Leveling pad BB and the first course of blocks are installed below grade. The wall is finished or capped, with cap layer 30. FIG. 9B illustrates a conventional retaining wall in which the retained soil is level with the top of the wall. The degree of set back for the wall is chosen based upon considerations of aesthetic appearance and necessary structural strength. The amount of set back is determined by the location of the pin-receiving apertures located in each block. The heads of shouldered pins 80 are received in a channel on the bottom surface of blocks in an upper course thus fastening the blocks of an upper course to those of a lower course.

FIGS. 10A and 10B illustrate a portion of a wall made with the blocks of the present invention in which block 300′ has been field split to produce block 300C. Block 300C, which is twice as long as the width of a single course, has been placed vertically in the wall to give a more natural random appearance.

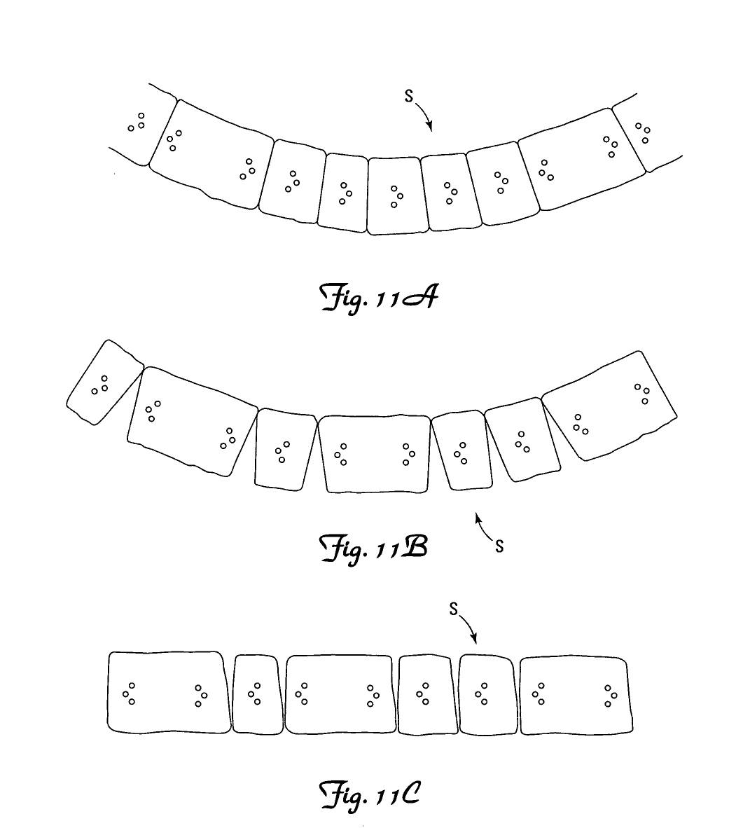

FIGS. 11A to 11C illustrate top views of other types of walls made with the blocks of the present invention. FIG. 11A illustrates a closed convex wall retaining soil S and where no gaps between blocks is present and is formed by placing an angled end of a first block adjacent the straight end of a second block forming a curvilinear wall. The closed wall could also be used in a freestanding wall where one side of the wall would be convex and one side would be concave reducing the potential daylight visibility through the wall. The closed retaining wall reduces the potential for the flow of retained soil through the wall due to rain. FIG. 11B illustrates an open concave wall retaining soil S where there are gaps between blocks where the soil is retained but no gaps visible on the front surface of the wall. The wall is constructed by placing the front surface of the blocks adjacent to front face of a second block. The openness of the blocks where the soil is retained allows for flexibility of design for the shape of the wall. FIG. 11C illustrates an open linear wall retaining soil S where there are gaps between blocks where the soil is retained but no gaps visible on the front surface of the wall. The wall is constructed by placing the front face of a block adjacent to front face of a second block. In an open retaining wall the longer face of the block is usually used as the front face in order to maximize the square foot coverage of the wall.

Although particular embodiments have been disclosed herein in detail, this has been done for purposes of illustration only, and is not intended to be limiting with respect to the scope of the claims. In particular, it is contemplated that various substitutions, alterations, and modifications may be made to the invention without departing from the spirit and scope of the invention as defined by the claims. For instance, the choice of materials or variations in the shape or angles at which some of the surfaces intersect are believed to be a matter of routine for a person of ordinary skill in the art with knowledge of the embodiments disclosed herein.

What is claimed is:

1. A mold assembly for use in producing wall blocks of different sizes comprising:
a horizontally oriented planar bottom member;
first and second opposing and parallel side walls;
first and second opposing and parallel end walls, the side walls and end walls being joined to form an enclosed perimeter portion, the bottom member enclosing a bottom of the enclosed perimeter portion, a top of the enclosed perimeter portion being open; and
a planar division plate having a first end adjacent the first end wall and a second end adjacent the second end wall, the division plate being oriented in a perpendicular position with respect to the pallet and dividing the enclosed perimeter portion into first and second mold cavities, each mold cavity having opposing cavity end walls formed by the parallel end walls of the enclosed perimeter portion, the division plate being positioned at an angle α with respect to the side walls, angle α being an acute angle greater than 0° such that each of the first and second mold cavities have parallel cavity end walls and non-parallel cavity side walls.

2. The mold assembly of claim 1 wherein the enclosed perimeter portion is square.

3. The mold assembly of claim 1 wherein the enclosed perimeter portion is rectangular.

4. The mold assembly of claim 1 wherein the first and second mold cavities are the same size.

5. The mold assembly of claim 1 wherein angle α is in the range of about 5° to 10°.

6. The mold assembly of claim 1 wherein angle α is about 7.125°.

7. The mold assembly of claim 1 further including at least one mold liner connected to at least one of the side walls, end walls, and division plate.

8. A method of making blocks of differing size comprising:
placing a mold over a horizontal pallet, the mold including first and second opposing and parallel side walls, and first and second opposing and parallel end walls, the side walls and end walls being joined to form an enclosed perimeter of the mold, the pallet enclosing a bottom of the enclosed perimeter portion, a top of the enclosed perimeter portion being open, the mold further including a planar division plate having a first end adjacent the first end wall and a second end adjacent the second end wall, the division plate being perpendicular to the pallet and dividing the enclosed perimeter portion into first and second mold cavities, each mold cavity having opposing cavity end walls formed by the parallel end walls of the enclosed perimeter portion, the division plate being positioned at an angle α with respect to the side walls, angle α being an acute angle greater than 0° such that each of the first and second mold cavities have parallel cavity end walls and non-parallel cavity side walls;
filling the mold cavities with a moldable material to form a first slab in the first mold cavity and a second slab in the second mold cavity;
applying downward pressure with a stripper head assembly to remove the first and second slabs from the mold;
curing the first and second slabs;
splitting the first slab into first and second blocks; and
splitting the second slab into third and fourth blocks, each of the first, second, third and fourth blocks having opposing and parallel first and second face surfaces and opposing and non-parallel first and second side walls.

9. The method of claim 8 wherein the enclosed perimeter portion is square.

10. The method of claim 8 wherein the enclosed perimeter portion is rectangular.

11. The method of claim 8 wherein the first and second slabs are the same size.

12. The method of claim 8 wherein angle α is in the range of about 5° to 10°.

13. The method of claim 8 wherein angle α is about 7.125°.

14. The method of claim 8 wherein the mold further includes at least one mold liner connected to at least one of the side walls, end walls, and division plate.

15. The method of claim 8 wherein a distance between the face surfaces of each of the first, second, third and fourth blocks is the same and a distance between the side walls of each of the first, second, third and fourth blocks as measured along the first face surface is different.

16. The method of claim 8 wherein the moldable material is one of zero slump concrete and wet cast concrete.

17. A mold assembly for use in producing wall blocks of different sizes comprising:
a horizontally oriented planar bottom member;
first and second opposing and parallel side walls;
first and second opposing and parallel end walls, the side walls and end walls being joined to form an enclosed perimeter portion, the bottom member enclosing a bottom of the enclosed perimeter portion, a top of the enclosed perimeter portion being open; and
at least three planar division plates, each division plate having a first end adjacent the first end wall and a second end adjacent the second end wall, the division plates being oriented in a perpendicular position with respect to the pallet and dividing the enclosed perimeter portion into a plurality of elongate mold cavities, each mold cavity having opposing cavity end walls formed by the parallel end walls of the enclosed perimeter portion, at least two of the at least three division plates being positioned at an angle α with respect to the side walls, angle α being an acute angle greater than 0°, at least one of the at least three division plates being parallel to the side walls and being positioned between the at least two division plates positioned at an angle α such that each of the plurality of mold cavities have parallel cavity end walls and non-parallel cavity side walls.

18. The mold assembly of claim 17 wherein the enclosed perimeter portion is square.

19. The mold assembly of claim 17 wherein the enclosed perimeter portion is rectangular.

20. The mold assembly of claim 17 wherein the plurality of mold cavities are the same size.

21. The mold assembly of claim 17 wherein angle α is in the range of about 5° to 10°.

22. The mold assembly of claim 17 wherein angle α is about 7.125°.

23. The mold assembly of claim 17 further including at least one mold liner connected to at least one of the side walls, end walls, and division plates.
